(19) United States
(12) Patent Application Publication
(10) Pub. No.: US 2026/0337949 A1
(43) Pub. Date: Oct. 29, 2026

(54) METHOD OF 3D-PRINTING

(71) Applicant: Robert PRINS, Amsterdam (NL)

(72) Inventor: Robert PRINS, Amsterdam (NL)

(21) Appl. No.: 19/152,272

(22) PCT Filed: Jan. 30, 2024
(86) PCT No.: PCT/NL2024/050043

§ 371 Date: Jul. 30, 2025

(30) Foreign Application Priority Data
Jan. 30, 2023 (NL) 2034044
May 17, 2023 (NL) 2034843

(51) Int. Cl. E04B 1/32; B28B 1/00; B33Y 10/00; B33Y 40/00

(52) U.S. Cl. CPC E04B 1/3211; B28B 1/001; B33Y 10/00; B33Y 40/00; E04B 2001/3252

(57) ABSTRACT

The invention is in the field of an apparatus for additive manufacturing of large objects, in particular houses or parts thereof. It therefore relates to manufacturing of large three-dimensional [3D] objects by additive deposition, additive agglomeration, or additive layering, e.g. by 3D printing, stereolithography or selective laser sintering. In particular to an apparatus specially adapted for additive manufacturing, more in particular auxiliary means for additive manufacturing relating to a combination of an additive manufacturing apparatus with other processing apparatus or devices, as well as to a method of 3D-printing.

### FIELD OF THE INVENTION

The invention is in the field of an apparatus for additive manufacturing of large objects, in particular houses or parts thereof. It therefore relates to manufacturing of large three-dimensional [3D] objects by additive deposition, additive agglomeration or additive layering, e.g. by 3D printing, stereolithography or selective laser sintering. In particular to an apparatus specially adapted for additive manufacturing, more in particular auxiliary means for additive manufacturing relating to a combination of an additive manufacturing apparatus with other processing apparatus or devices, as well as to a method of 3D-printing.

### BACKGROUND OF THE INVENTION

The present invention relates to an improved apparatus for 3D-printing. 3D printing or additive manufacturing relates to construction of a three-dimensional object based on a computer model thereof. The model is fed into the 3D-printing apparatus, which then constructs a physical model by a layer-on-layer approach, such as deposition. A variety of processes may be used to this end, such as deposition, joining, or solidifying, etc. Also a variety of materials may be used, such as plastics, liquids, and powder grains. Over the years the precision, repeatability, and material range of 3D printing have increased.

The computer model is typically presented as a computer file. It is common practice to check the file for errors and fix the errors in order to improve the printing process. Note that in the end the printing process relates to a point-by-point additive manufacturing, in a layer-by-layer mode. That is why typically a 3-D computer model is provided in relatively thin slices, each slice having substantially the same thickness as the layer above. The printer is controlled by a computer, and typically builds the physical 3-D model slice by slice, or layer by layer. The printer resolution typically is around 100 um (or 250 DPI), although some machines can print thinner layers. The particles used are clearly in the order of the printer resolution, or somewhat smaller. As the 3D-process is in a layer-by-layer basis, construction of a model is not very quick, an may consume at least several hours and often several days, depending on the method used and the size and complexity of the model.

For printing single materials can be used, such as polymers, metals, resins, ink, and so on. Also multi-material 3D-printing is possible. Application of 3D-printing can be found in a variety of sectors, such as in the health sector, in the education sector, in food industry, in fashion industry, in transportation industry, and so on. The use of 3D-printing is however typically limited to not too large objects.

Incidentally reference can be made to the following documents: US 2022/032500 A1 recites a method and a construction and/or a materials-handling machine for guiding and moving a working head, in particular a 3D print head, wherein at least three revolving tower cranes are attached to each other with their booms, wherein according to one aspect of the invention a guide beam carrying the working head is attached to at least two trolleys of two revolving tower cranes, and the working head is adjusted and moved in its working position by moving the trolleys along two booms of two revolving tower cranes. US 2015/239148 A1 recites systems and methods are disclosed for spray printing construction. In some embodiments, a system may include a rotating truss, which in some embodiments may be arch-shaped. The system may further include a sprayer apparatus configured to connect to and move along the truss, and a processor circuit configured to execute computer instructions to print a building structure using the sprayer apparatus and the rotating truss. In another embodiment, a method may include determining a spray pattern for creating a printable structure at a computer control system, and implementing, on the computer control system, the spray pattern to create the printable structure, including rotating an arched truss system supporting an adjustable spray printer, adjusting a position of the spray printer on the arched truss system, and activating the spray printer to execute the determined spray pattern. KR 2021 0023937 A recites a) concrete, concrete rods, concrete spirals, concrete mesh rod frames, concrete rod frame spirals, and concrete mesh rod frame spirals on which magnets, electromagnets, magnetic bodies, superconducting magnets, solenoid electromagnets, and the like are mounted, hollow bodies in which the same is embedded, and equipment, such as concrete placement machines, wind compressors, drones, solar generators, and wind generators, which has the same b) magnetized materials or materials containing Ca, Mg, Si, Fe, Me, Al, K, Na, OH, COO, CaSi, CaFe, or the like, mortar, milk, remicon, and concrete undergoing the same, c) materials, bricks, blocks, main materials, sub-materials, and construction materials used in the equipment or concrete, and d) methods, construction methods, manufacturing, construction, and pouring methods, facilities, buildings, structures, and the like using the equipment or construction materials. Therefore, the material function, performance and effect of cement, remicon, concrete, or the like can be increased.

The present invention therefore relates to an improved apparatus for 3D-printing, which overcome one or more of the above disadvantages, without jeopardizing functionality and advantages.

### SUMMARY OF THE INVENTION

The present invention relates in a first aspect a support structure for 3D-printing 100, comprising a frame, selected from a rectangular frame, a hexagonal frame, a multigonal frame, wherein the frame is adapted to be included in the 3D structure, wherein, for a dome shaped-frame, and the substantially dome-shaped frame 10 has a substantially circular cross-section, in particular a hemispherical dome, the frame comprising a bottom support 11, in particular having substantially the same cross-section as the frame, and at least two beams 12, the beams evenly divided over the circumference of the bottom support, in particular wherein the beams are attached to the bottom support, at least one guidance 13 for a 3D-printing device 14, or wherein the rectangular frame comprises at least one upright member (21) per side, and at least one horizontal cross member (22) connecting the upright members, and wherein the rectangular frame is adapted to be included in the 3D structure, wherein the guidance is located inside the frame, and wherein the guidance is adapted to provide movement of the 3D-printing device. In particular particle deposition is used by the 3D-printing device, in particular wherein the guidance is adapted to move in a vertical direction inside the frame. In view of the housing construction issues in general, such as caused by an increasing population or increasing demand, or caused by natural disasters, a need for quicker building techniques is present. Therefore the present invention provides a support structure that is particularly suited for 3D-printing of larger structures, such as houses. In principle it can be used for smaller structures as well. Therewith a quick and reliable technique is provided for making such structures. In particular the present support structure provides a good control of an interior temperature and of humidity; therewith a good control of the 3D-printed structure is obtained and thus reliable results. The interior temperature is controlled within ±1K within 10 minutes without any further measure. If further measures are applied the temperature is controlled within ±1K within 60 minutes, which is considered sufficient for 3D-printing of e.g. clay, concrete, cement, etc. The technique is readily scalable. It does not involve much human labor. Although the process of 3D-printing is not very quick, still buildings can be constructed in shorter time-frames than with traditional building techniques. In particular the 3D-printer can make use of large particles and/or use thicker layer, such as of 0.5-10 cm, in particular 2-5 cm. A resolution of accuracy of 1 mm is typically more than sufficient for constructions: note that in traditional construction accuracies of about 1 cm are reached, in particular when a plurality of materials is involved. Of course for example wood-wood constructions, or the like, can be very precise, but when incorporating such structures resolution/accuracy is lost to some extent. Even further, when including the frame in the 3D-structure that is 3D-printed, production time is saved, production costs are reduced, a more stable and stronger construction is obtained, and standardization is possible. There is no need for forming complex 3D-printing systems. The frame may also include or consist of supporting elements, such as for supporting a balcony. In the latter case part of the frame elements for the house may be erected during the construction, in particular when a 3D-printer in use is not capable of printing under an oblique angle.

The present support structure for 3D-printing may comprise two or more 3D-printers, also referred to as 3D-printing devices, in particular 4-6 3D-printers. In an exemplary embodiment of the present support structure the at least one guidance is configured to move a first 3D printer over a first subsection of the frame, and wherein the at least one guidance is configured to move a further 3D printer over a further subsection of the frame, in particular wherein the at least one guidance is configured to move each 3D-printer independently over a subsection, or in particular wherein the at least one guidance is configured to move each 3D-printer independently fully over the at least one guidance, or in particular a combination thereof. Each 3D-printing device may in addition or as an alternative provide a same or a different printing material, e.g. such that external wall and internal walls, or bathroom walls, each individually can be made of and printed by a different printing material. Further, a limited number of construction works, typically 2-5, can easily construct a house or the like within a limited time frame of e.g. much less than one month or so, and typically in a few days time. Further elements as windows and so on are typically included in the 3D structure while constructing it.

The present invention finds (or is intended to find) application in Oudkarspel, Amsterdam, and possibly Lissebroek in the Netherlands, in Prenzlau and Postdam in Germany, in Pula in Croatia, and possibly in Dubai. Therewith it is clear that the resent invention is already well recognized in the field.

In a second aspect the present invention relates to a method method of producing a house, comprising providing the support structure for 3D-printing according to any of claims 1-10 and at least one 3D-printing device, providing printing material to the at least one 3D-printing device, such as at least one of clay, cement, or concrete, and 3D-printing the house or part thereof with said at least one 3D-printing device, by printing material layer by layer while moving said at least one 3D-printing device over the at least one guidance (13) of said support structure, and therewith including said frame in the 3D-printed house or part thereof. Typically a foundation or the like may be provided. Then the present frame as such or in parts typically is provided. The present frame may be constructed of standardized parts, e.g. in terms of lengths, widths, and heights. The frame may have beams, typically of any suitable cross-section, such as H-profile, I-profile, L-profile, Y-profile, rectangular, hollow, and so on. When hollow, further elements as piping and cables can be included in the hollow frame. In principle for an H-shaped-beam, or any other shaped beam with spacing, the piping and cables could also be incorporated in said spacings. The beams may be attached to one and another, such as by welding, or attachable to one and another, such as by bolts, or a combination thereof. The frame may be formed from any suitable material, such as metal, such as stainless steel, iron, aluminium, and combinations thereof. Also wood and reinforced concrete are possible. The guidance is attached to the frame, typically removably attached, as, when finished, the guidance is typically removed from the frame. Likewise the at least one 3D-printing device is removably attached to the guidance. The guidance can move over the frame, typically in a vertical direction, in particular in case of a rectangular frame. In case of e.g. a dome-shaped frame the guidance may provide full movement over the dome of the at least one 3D-printing device. Printing is carried out layer by layer, using one or more 3D-printing devices (see FIGS. 7-12, representing various phase of printing). Doors, windows, etc. can be incorporated in the printed 3D-structure, directly after finishing an according part, at the end of construction of the 3D-structure, or during construction. Flors/ceiling can be printed, optionally comprising reinforcement elements, or can be provided as such, and put into place. Inner wall and outer walls are typically provided more or less at the same time, that is, the 3D-structure increases in height layer by layer, wherein each subsequent layer is provided on a previous layer, or foundation, for both the inner and outer walls. The 3D-structure may comprise openings and voids, for providing said windows, doors, etc. and for providing electrical connections, water supply, heating, etc. Typically after finishing the 3D-structure the further house piping and plumbing and the like is provided. Therewith, layer by layer, the house or part thereof is formed, from bottom to top. The present frame is included in the structure that is formed, and forms an integral part thereof. As such, the frame may be considered as a structural element of the house, e.g. for supporting floors. The guidance moves upwards, and the guidance and the 3D-printing device are removed once completed. The frame may extend above a final top element of the structure, wherein the top element is selected from a ceiling, a roof, etc.

Thereby the present invention provides a solution to one or more of the above-mentioned problems.

Advantages of the present invention are detailed throughout the description.

### DETAILED DESCRIPTION OF THE INVENTION

The present invention relates in a first aspect to a support structure for 3D-printing 100.

In an exemplary embodiment of the present support structure for 3D-printing the at least one guidance 13 is adapted to provide movement in a Cartesian coordination system, in particular over at least three axis, more in particular over an x, y, and z-axis, more in particular wherein the origin of the axis is in the centre of the bottom support.

In an exemplary embodiment of the present support structure for 3D-printing the guidance 13 is adapted to provide movement in a spherical coordination system, in particular over a radial distance of the 3D-printing device from a fixed origin, over a polar angle measured from a fixed zenith direction, and over an azimuthal angle of its orthogonal projection on a reference plane that passes through the origin and is orthogonal to the zenith, measured from a fixed reference direction on that plane.

In an exemplary embodiment of the present support structure for 3D-printing the frame 10 comprises at least one external fixator 15 a for compensating gravitational force of the 3D-printing device, and/or wherein the frame 10 comprises at least one internal fixator 15b for compensating gravitational force of the 3D-printing device.

In an exemplary embodiment of the present support structure for 3D-printing the at least one fixator 15a comprises a cable, the cable at one end being fixed to the frame, and at another end to mass, in particular wherein the cable is tensed over at least one post.

In an exemplary embodiment of the present support structure for 3D-printing the frame comprises solar panels, in particular curved solar panels, more in particular solar panels provided over the outside of the frame.

In an exemplary embodiment of the present support structure for 3D-printing the frame comprises panels for separating an interior of the dome from an exterior thereof

In an exemplary embodiment the present support structure for 3D-printing comprises at least one hook for tightening the frame to a surface, in particular for tightening the ring to the surface of the earth.

In an exemplary embodiment of the present support structure for 3D-printing the frame has a diameter of 5 -25 meters, and a height of 2-10 meters.

In an exemplary embodiment of the present support structure for 3D-printing the frame may extend above a covering element of a 3D-printed house, in particular wherein the covering element is selected from a ceiling, and a roof. In an exemplary embodiment of the present support structure for 3D-printing the 3D-printing device is configured for printing a house or part thereof.

In an exemplary embodiment of the present support structure for 3D-printing the dome-shaped frame comprises a flattened top, in particular wherein the top is flattened from 30-60 degrees taken from a bottom of the frame, more in particular wherein the flattened top is provided with a fence.

In an exemplary embodiment the present method of producing a house comprises controlling movement of the 3D-printing device over the guidance, in particular with at least one step-motor, or with an optical controlling device.

In an exemplary embodiment the present method of producing a house comprises first printing a first storey, the first storey comprising at least one of a foundation, a wall, a floor, and a spacing for a post for a door or window, in particular a lower storey, then providing a support on top of the first storey, and providing at least one further storey, the further storey comprising at least one of a foundation, a wall, a floor, a spacing for a post for a door or window. The spacing may be supplied with an element spanning an area between two parts.

The present invention also relates to a method of operating a storage box system comprising at least one storage box according to the invention, comprising loading software instructions onto an electronic user device, such as an app on a smartphone, contacting the electronic user device with a central operation control device, identifying at least one available bicycle storage stall by the central operation control device, temporarily reserving at least one available bicycle storage stall by the central operation control device, sending identification particulars of the available bicycle storage stall to the electronic user device and receiving said particulars on said electronic user device, finally reserving the available bicycle storage stall via said electronic user device or requesting a further available bicycle storage stall and optionally repeating above steps, and closing the communication.

The present invention also relates to a computer program comprising instructions, the instructions causing the computer to carry out the following steps: loading software instructions onto an electronic user device, such as an app on a smartphone, contacting the electronic user device with at least one 3D-printing device in the present support structure, and providing instructions to the at least one 3D-printing device for 3D-printing the house or part thereof, wherein the at least one 3D-printing device is instructed to print printing material layer by layer while moving over the at least one guidance (13) of said support structure, and therewith including said frame in the 3D-printed house or part thereof.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

### SUMMARY OF THE FIGURES

FIG. 1-12 show exemplary embodiments of the present invention.

### DETAILED DESCRIPTION OF THE FIGURES

In the figures:
100 support for 3D-printing
10 dome shaped frame
11 circular bottom support
12 semi-circular beam
13 guidance
14 3D-printing device
15a external fixator
15b internal fixator
21 upright frame member
22 horizontal frame member

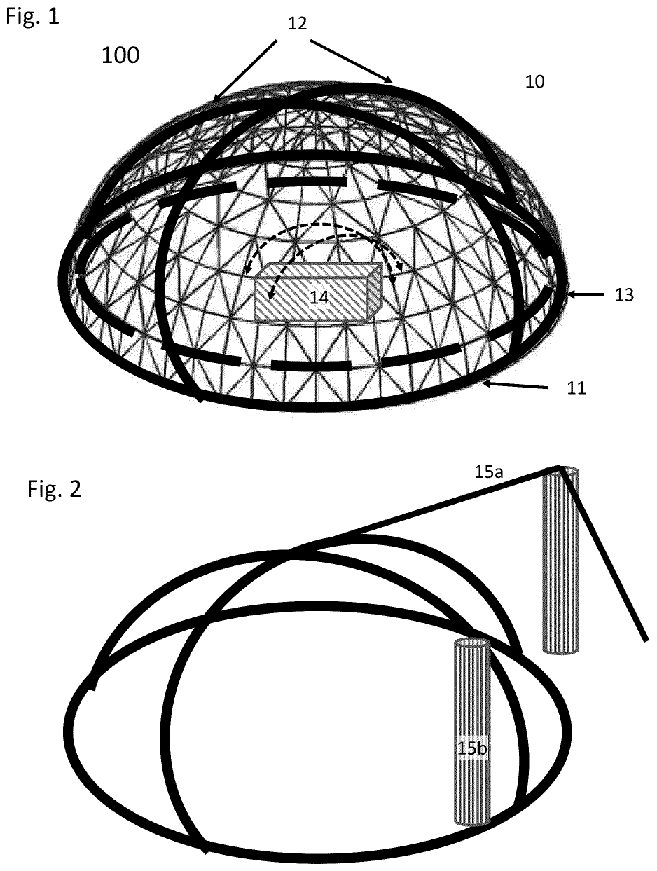

FIG. 1 shows an example of the present support structure.

FIG. 2 shows details of the present support structure.

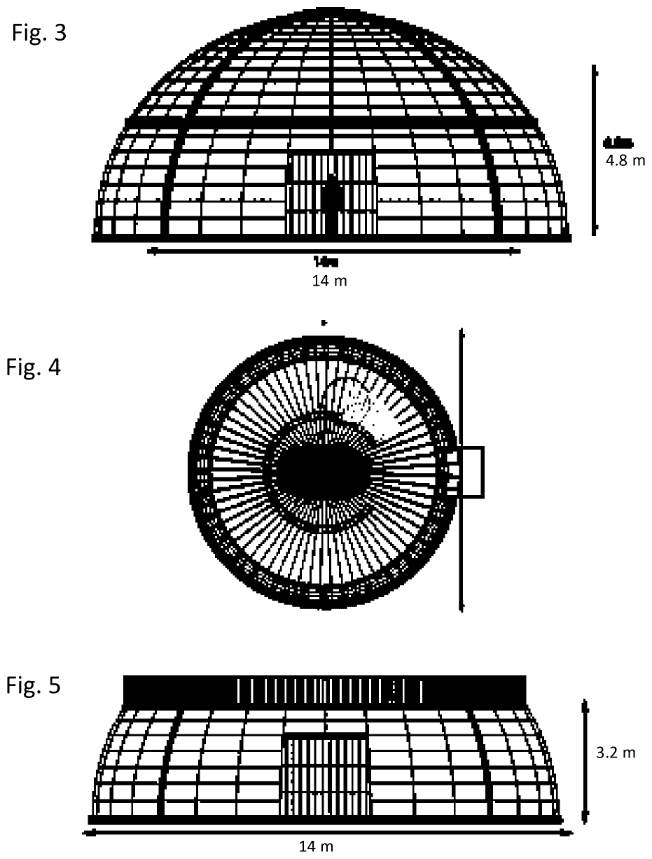

FIGS. 3-12 show examples of the present support-structure, wherein in FIG. 5 a fence is shown.

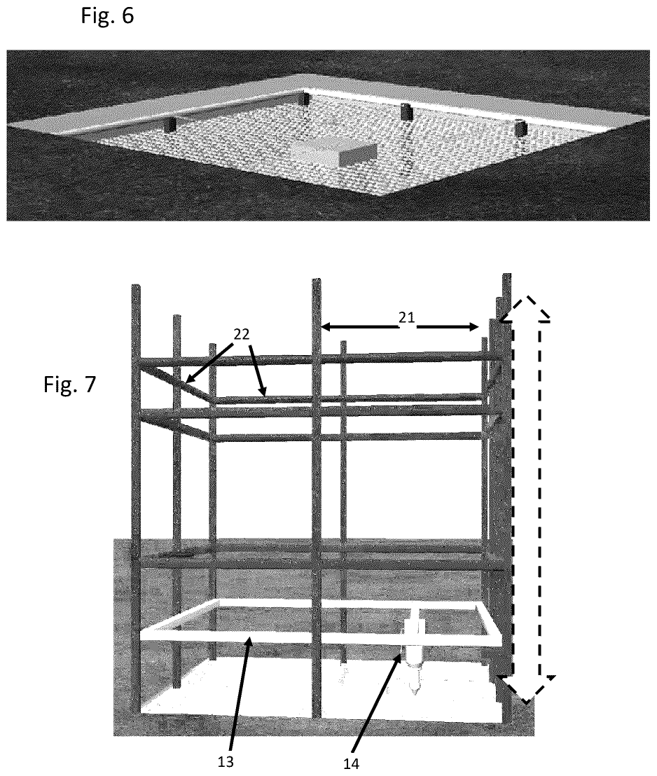

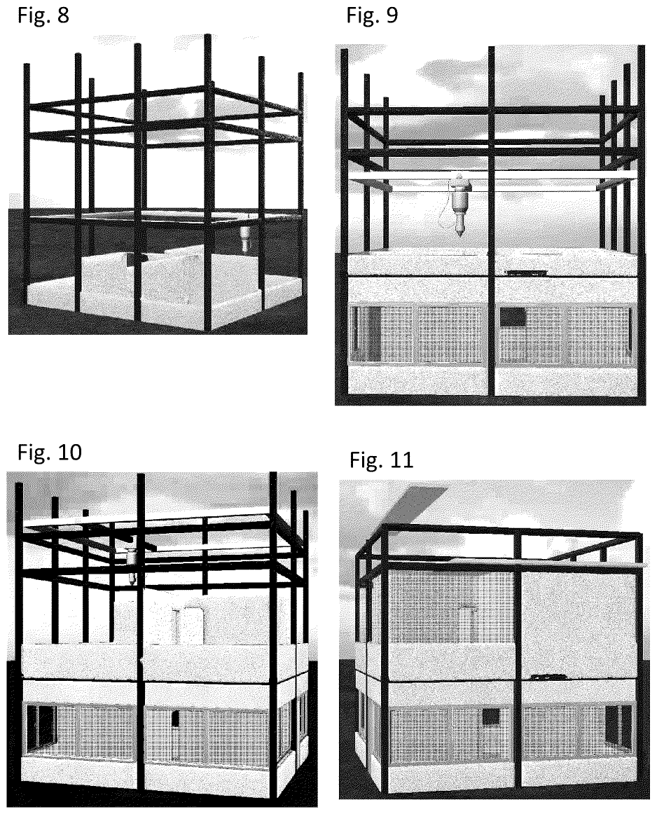

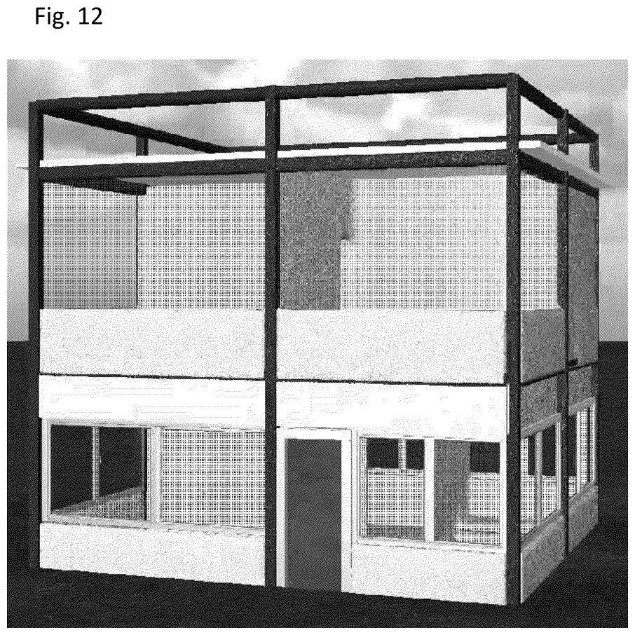

FIG. 6 shows preparation works, wherein a foundation is provided. FIG. 7 shows a rectangular frame, with three upright members 21 per side, and three horizontal cross members 22 per side. In general, these members may be made from a metal, such as steel, and aluminum, from concrete, and combinations thereof. The guidance 13 is vertically movable and attached to the frame at an inside. The guidance can be removed when construction is finished. Attached to the guidance a 3D printing device 14 is provided. FIG. 7 shows printing of a lower part of a building to be formed. FIGS. 8-12 show further stages of construction. The rectangular frame is incorporated in the 3D-printed structure. Further, frames for windows and doors and the like are incorporated, as well as floors/ceilings. The latter may be provided as such, or as parts (see e.g. FIG. 11). FIG. 12 shows a completed house.

The figures are further detailed in the description and examples below.

1. A support structure for 3D-printing of a 3D-structure, comprising
a frame, selected from a rectangular frame, a hexagonal frame, a multigonal frame, and a substantially dome-shaped frame, wherein the frame is adapted to be included in the 3D structure, wherein, for a dome shaped-frame, the dome-shaped frame has a substantially circular cross-section,
at least one guidance for a 3D-printing device wherein the guidance is located inside the frame, and wherein the guidance is adapted to provide movement of the 3D-printing device, in particular wherein the guidance is adapted to move in a vertical direction inside the frame.

2. The support structure for 3D-printing according to claim 1, wherein the frame comprises a bottom support, in-particular having substantially the same cross-section as the frame, and at least two beams the beams evenly divided over the circumference of the bottom support, wherein the beams are attached to the bottom support, and
wherein the guidance is adapted to provide movement in a Cartesian coordination system, over at least three axis.

3. The support structure for 3D-printing according to claim 1, wherein the at least one guidance is adapted to provide movement in a spherical coordination system, a movement is over a radial distance of the 3D-printing device from a fixed origin, and over a polar angle measured from a fixed zenith direction, and over an azimuthal angle of its orthogonal projection on a reference plane that passes through the origin and is orthogonal to the zenith, measured from a fixed reference direction on that plane.

4. The support structure for 3D-printing according to claim 1, wherein the frame comprises at least one external fixator for compensating gravitational force of the 3D-printing device, and/or wherein the frame comprises at least one internal fixator for compensating gravitational force of the 3D-printing device.

5. The support structure for 3D-printing according to claim 4, wherein the at least one fixator comprises a cable, the cable at one end being fixed to the frame, and at another end to mass, wherein the cable is tensed over at least one post.

6. The support structure for 3D-printing according to claim 1, wherein the frame comprises solar panels, more and
wherein the frame comprises panels for separating an interior of the dome from an exterior thereof.

7. The support structure for 3D-printing according to claim 6, comprising at least one hook for tightening the frame to a surface, of the earth.

8. The support structure for 3D-printing according to claim 7, wherein the frame has a diameter of 5 -25 meters, and a height of 2-10 meters, and wherein the frame has a height that extends above a covering element of a 3D-printed house, wherein the covering element is selected from a ceiling, and a roof.

9. The support structure for 3D-printing according to claim 1, wherein the 3D-printing device is configured for printing a house or part thereof.

10. The support structure for 3D-printing according to claim 1, wherein the dome-shaped frame comprises a flattened top, in wherein the top is flattened from 30-60 degrees taken from a bottom of the frame, wherein the flattened top is provided with a fence.

11. A method of producing a house, comprising providing the support structure for 3D-printing according to claim 1, at least one 3D-printing device,
providing printing material to the at least one 3D-printing device, wherein the printing material is at least one of clay, cement, and concrete, and
3D-printing at least part of the house layer by layer with said at least one 3D-printing device, by printing material while moving said at least one 3D-printing device over the at least one guidance of said support structure, and
therewith including said frame in the at least part of the 3D-printed house.

12. Method of producing a house according to claim 11, comprising
controlling movement of the 3D-printing device over the guidance, with at least one of a step-motor, and an optical controlling device.

13. Method according to claim 11, comprising first printing a first storey, the first storey comprising at least one of a foundation, a wall, a floor, and a spacing for a post for a door or window,
then providing a support on top of the first storey, and
providing at least one further storey, the further storey comprising at least one of a wall, a floor, and a spacing, wherein the spacing is selected from a spacing for a post for a door for a window.

14. An electronic user device comprising a processor and a computer program comprising instructions, the instructions causing the electronic user device to carry out the following steps: loading software instructions onto an electronic user device, contacting the electronic user device with at least one 3D-printing device in the support structure for 3D-printing according to claim 1, and providing instructions to the at least one 3D-printing device for 3D-printing at least part of the house, wherein the at least one 3D-printing device is instructed to print printing material layer by layer while moving over the at least one guidance of said support structure, and
therewith including said frame in the 3D-printed house.

15. The support structure for 3D-printing according to claim 1, comprising two or more 3D-printers.

16. The support structure for 3D-printing according to claim 15, wherein the at least one guidance is configured to move a first 3D-printer over a first subsection of the frame, and wherein the at least one guidance is configured to move a further 3D-printer over a further subsection of the frame, wherein the at least one guidance is configured to move each 3D-printer independently over a subsection, and wherein the at least one guidance is configured to move each 3D-printer independently fully over the at least one guidance.

17. The support structure for 3D-printing according to claim 1, wherein the rectangular frame comprises at least one upright member per side, and at least one horizontal cross member connecting the upright members, and wherein the rectangular frame is adapted to be included in the 3D structure.
